(19) United States
(12) Patent Application Publication
(10) Pub. No.: US 2003/0233160 A1
(43) Pub. Date: Dec. 18, 2003

(54) Method and device for product data processing

(76) Inventor: Tomotoshi Ishida, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/463,583

(22) Filed: Jun. 18, 2003

(30) Foreign Application Priority Data
Jun. 18, 2002 (JP) 2002-176751

(51) Int. Cl. G06F 19/00

(52) U.S. Cl. 700/106

(57) ABSTRACT

A product data processing method, and device, for outputting indexes useful to select parts having actual results, so as to be associated with a part list in a design stage is provided. Past product data and its product attribute data are input, developed into attribute data with a part as the unit, and stored in a part attribute data storage region. New product data is input, and the part attribute data storage region is searched for attribute data of a part unit in part attribute data. Attribute data is associated with each of pertinent parts. Product data with attribute including the number of manufactured, sold, or recovered articles is thus created and stored. When used in the development stage of a new product, reliability and productivity improvement and cost reduction for a designed product is attained from the situation of manufactured, sold and recovered (recycled) parts.

### BACKGROUND OF THE INVENTION

The present invention relates to a device, and method, for supporting business by utilizing information concerning products or parts when conducting development, manufacture, or sale of a product including a plurality of parts.

It has been widely conducted from the past to handle data of parts included in an assembled product and various attribute data concerning the product or parts. For example, a method of making production plans of parts on the basis of a production plan of a product is concretely shown in Japanese literature “MRP for SE” written by Noboru Toba, and published by Nikkan Kogyo Shinbunsha in 1995, pp. 55-75 and 107-136.

On the other hand, in design of a new product, it is recommended from the past to use the same parts as those used in other products in the past, in the new product if possible, for the purpose of standardization of parts, cost reduction, and reliability improvement. Therefore, there is used a system that is responsive to input of data for specifying a part, such as a part number, to indicate whether the part has been used before in order to support the part selection.

### SUMMARY OF THE INVENTION

In preferentially using parts used in the past in design of a new product, a part that is newer in time of use is preferable to a part that is older, and a part that is less in the number of times of use is preferable to a part that is more, even if they are parts used in the past in the same way. Heretofore, however, there has not been a system provided while taking these into consideration.

At the time of design, a plurality of design plans are made and evaluated synthetically in many cases. At this time, it is not possible to take a look at a product configuration created as a plan and refer to past use situations of respective parts associated with each other.

It is desired to refer to the situation in which the manufacture, sale, repair, recovery, and recycle were conducted, and regional and temporal changes as factors of use situations of past parts. Heretofore, however, there has been no approach and means for conducting it.

An object of the present invention is to provide a product data processing device, and method, capable of solving the problem and outputting use situations or states of respective parts included in a product, such as a use lists, and the number of parts used part so as to be associated with each other together with a product configuration.

Another object of the present invention is to provide a program and a storage medium for the product data processing.

In order to achieve the objects, in accordance with one aspect of the present invention, there is provided a product data processing method for creating data useful for adopting parts in product development on the basis of past product data, comprising the steps of: developing input first product data indicating a hierarchical structure of a product and attribute data of the product into attribute data with a part taken as unit, and storing resultant attribute data, on the basis of the product data and the attribute data; and searching for the attribute data with a part taken as the unit for each of parts included in second input product data, adding the attribute data to each of pertinent parts, and creating product data with attribute corresponding to the second product data.

In accordance with another aspect of the present invention, attribute data in the product data with attribute is evaluated from part to part, and the attribute data is displayed together with a result of the evaluation.

The hierarchical structure of the product data includes hierarchical structure data including at least one assembly and subassembly and a plurality of parts. And the product attribute data is the number of manufactured articles, the number of sold articles, or the number of recovered articles with an assembly taken as the unit.

In accordance with a product data processing method according to another aspect of the present invention, attribute data concerning the number of manufactured articles, the number of sold articles, the number of repaired articles, the number of recovered articles, or the number of recycled articles is read for the whole of or each of regional or temporal divisions of products including one kind or a plurality of kinds. And product configuration data of the pertinent product as a whole is read. The number of manufactured articles, the number of sold articles, the number of repaired articles, the number of recovered articles, or the number of recycled articles for a product taken as the unit is developed into parts. Subsequently, product configuration data of a second product is read. A list of parts included in the product is associated with data concerning the number of manufactured articles, the number of sold articles, the number of repaired articles, the number of recovered articles, or the number of recycled articles developed by taking a part in the parts included in the list as the unit. Product data with attribute for each of parts included in the second product is created. In addition, at this time, a corresponding part is evaluated on the basis of a predetermined evaluation condition concerning the number of manufactured articles, the number of sold articles, the number of repaired articles, the number of recovered articles, or the number of recycled articles. The product data is output together with a result of the evaluation.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a product data processing device according to an embodiment of the present invention;

FIG. 2 is a diagram showing a part configuration of a whole product;

FIG. 3 is a diagram showing a part configuration of a part of a product;

FIG. 4 is a diagram showing a part configuration of a part of a product;

FIG. 5 is a diagram showing a part configuration of a product to be developed;

FIG. 6 is a diagram showing a part configuration of a product;

FIG. 7 is a diagram showing a data configuration of product data;

FIG. 8 is a diagram showing a data configuration of product attribute data (the number of manufactured articles);

FIG. 9 is a diagram showing a data configuration of product attribute data (the number of sold articles);

FIG. 10 is a diagram showing a data configuration of product attribute data (the number of recovered articles);

FIG. 11 is a diagram showing a data configuration obtained by attaching attribute data (the number of manufactured articles) to parts;

FIG. 12 is a diagram showing a data configuration of product data shown in FIG. 5, by using a table form;

FIG. 13 is a diagram showing a data configuration of product data obtained by attaching the number of manufactured articles to each of parts;

FIG. 14 is an output diagram showing a data configuration of product data obtained by attaching the number of manufactured articles and evaluation to each of parts;

FIG. 15 is an output diagram showing a data configuration of part data obtained by attaching the number of manufactured articles and evaluation to each of parts;

FIG. 16 is an output diagram obtained by reflecting evaluation of actual result numbers of parts in FIG. 5;

FIG. 17 is an output diagram showing a data configuration of product data obtained by attaching the number of soled parts and evaluation to each of parts;

FIG. 18 is an output diagram showing a data configuration of product data obtained by attaching the number of recovered parts and evaluation to each of parts;

FIG. 19 is a flow diagram showing a processing procedure of a product data processing device according to an embodiment of the present invention;

FIG. 20 is a flow diagram showing development processing on part attributes in FIG. 19;

FIG. 21 is a flow diagram showing attribute association processing conducted in FIG. 19;

FIG. 22 is a diagram showing a data configuration obtained by adding attributes to highest rank parts;

FIG. 23 is a diagram showing a data configuration obtained by adding attributes to second highest rank parts;

FIG. 24 is a diagram showing a data configuration obtained by adding attributes to lowest rank parts;

FIG. 25 is a diagram showing a data configuration obtained by adding attributes to other second highest rank parts;

FIG. 26 is a diagram showing a data configuration obtained by adding attributes to still other second highest rank parts;

FIG. 27 is a diagram showing a data configuration obtained by conducting arrangement on the data configuration shown in FIG. 26;

FIG. 28 is a diagram showing a data configuration obtained by attaching attribute data (the number of sold articles) to each of parts; and

FIG. 29 is a diagram showing a data configuration obtained by attaching attribute data (the number of recovered articles) to each of parts.

### DETAILED DESCRIPTION OF THE EMBODIMENTS

Hereafter, embodiments of the present invention will be described with reference to the drawings. First, data of sample products used for description will now be described.

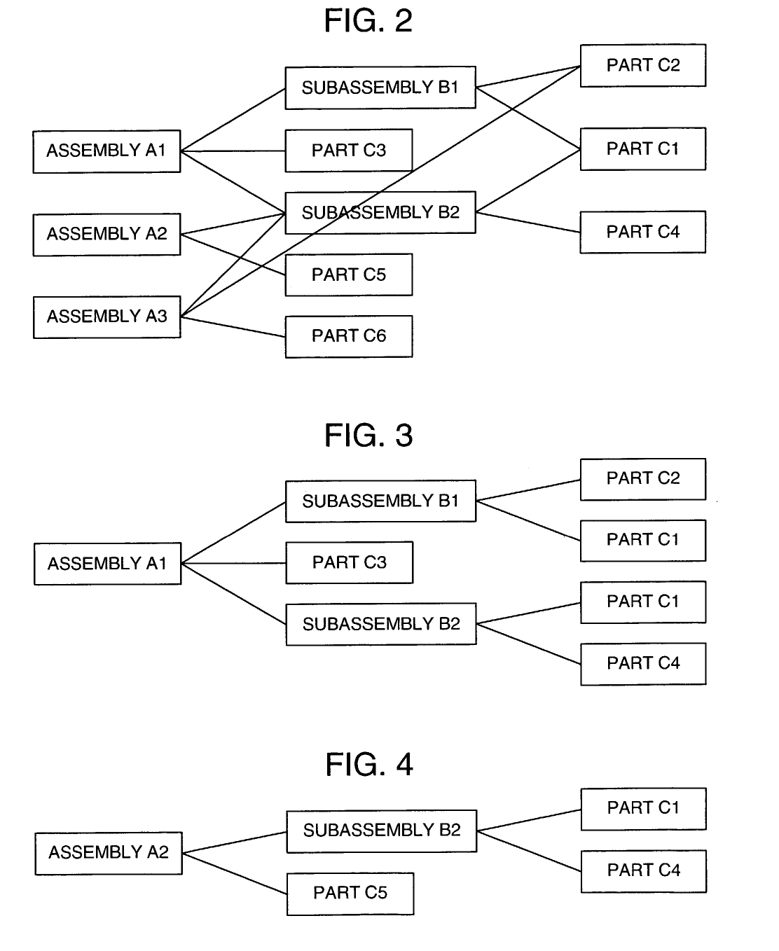

FIG. 2 is a hierarchical structure diagram showing assemblies A1, A2 and A3, which are three products, and their part configurations. FIG. 2 shows that the assembly A1 includes a subassembly B1, a part C3, and a subassembly B2, the subassembly B1 includes a part C2 and a part C1, and the subassembly B2 includes a part C1 and a part C4. Connections of the part C1 to the subassembly B1 and the subassembly B2 indicate that the part C1 of the same model is included in both the subassembly B1 and the subassembly B2. The same holds true for the assembly A2 and the assembly A3.

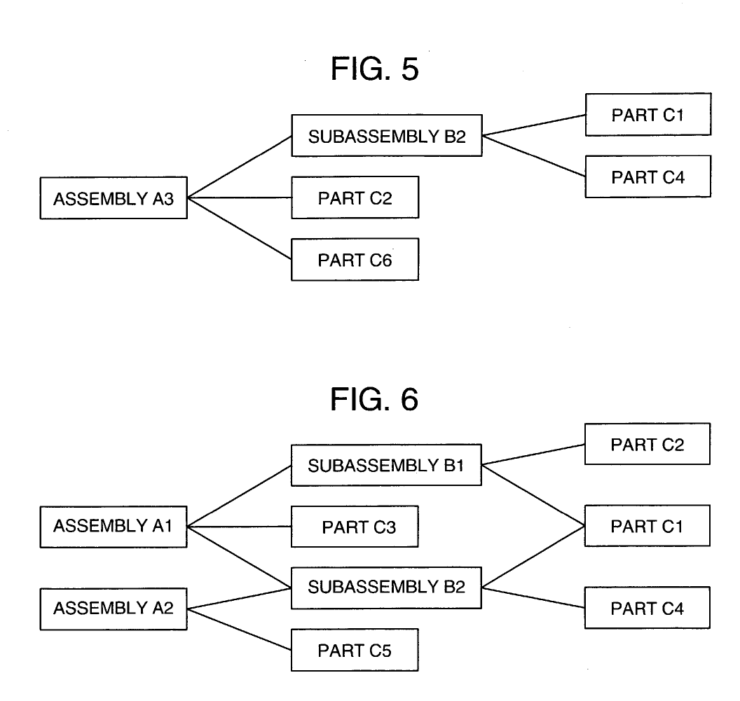

FIG. 3, FIG. 4 and FIG. 5 are hierarchical structure diagrams showing part configurations of the assembly A1, the assembly A2 and the assembly A3, respectively. FIG. 3, FIG. 4 and FIG. 5 are obtained by making the same data as that of FIG. 2 independent from product to product. Although the representation method is different from that of FIG. 2, FIG. 3, FIG. 4 and FIG. 5 represent the same subject as that of FIG. 2.

FIG. 6 represents only the product A1 and the product A2 by using the same representation method as that of FIG. 2. In the following description, it is assumed that the products A1 and A2 are products manufactured in the past and the product A3 is an example of a product plan that is now under design.

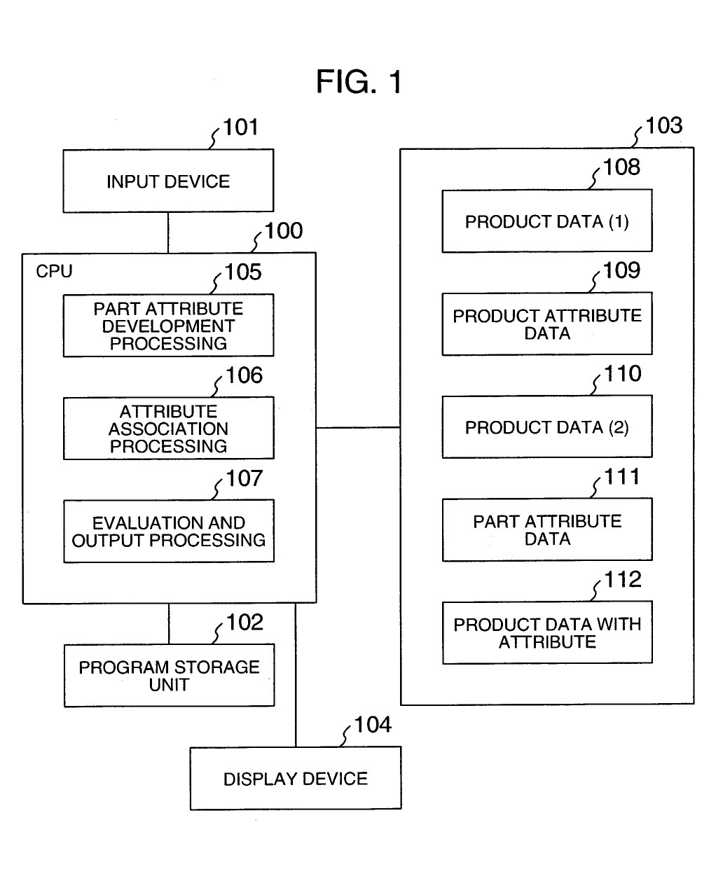

FIG. 1 is a configuration diagram of a product data processing device that represents a typical embodiment of the present invention. The product data processing device has a computer device including a CPU 100, a storage 103, an input device 101, and a display device 104. A unit 102 for storing a program to be executed by the CPU has a portable configuration by using, for example, a CDROM 102. It is also possible to store a program recorded on a portable medium, in another program storage unit.

The input device 101 is a device for inputting various data described later. Depending on circumstances, data is input by a person in an interactive form, or the input device is connected to another computer system to input data.

In a product data storage region (1) 108, data of past product data is recorded. This data is input typically from the input device 101. Depending on circumstances, however, it is also possible to start operation in a state in which the data is recorded previously. The recorded product data is, for example, data as shown in FIG. 6. It is proper to store such data in a form that can be easily handled by a computer.

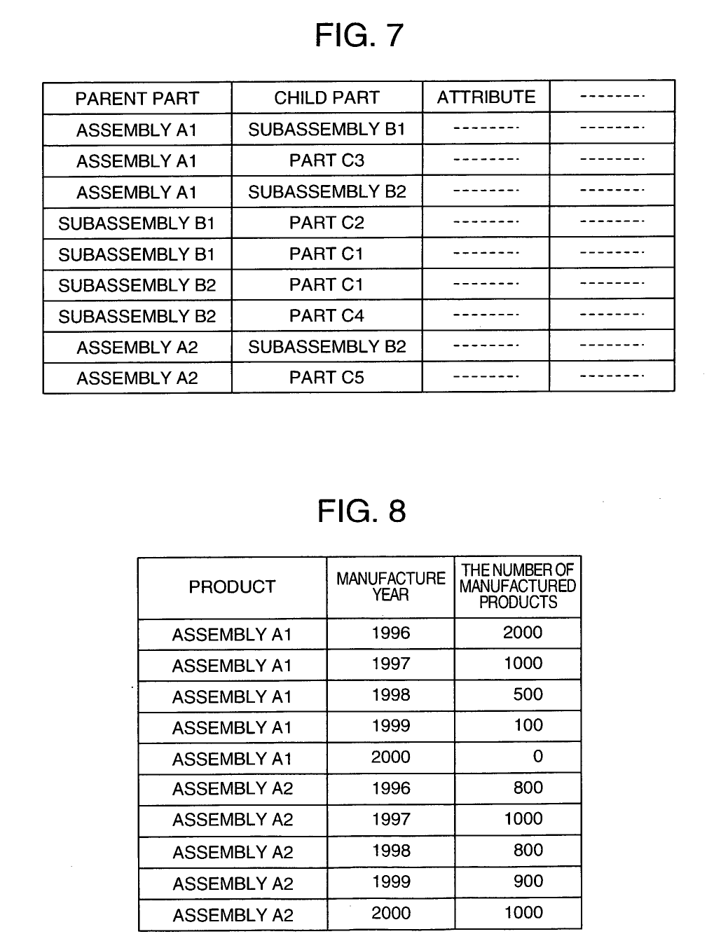

FIG. 7 is a diagram showing a data configuration of stored past product data. Respective rows in FIG. 7 correspond to lines that connect assemblies and parts shown in FIG. 6. A field of parent part represents assemblies located on the left side of lines in FIG. 6, and a field of child part represents assemblies located on the right side of lines in FIG. 6. A field of attribute and subsequent fields are regions capable of recording data relating to parts according to the purpose.

In a product attribute data storage region 109, data representing the number of manufactured articles for every past product and every term is recorded. Typically, this data is input typically from the input device 101. Depending on circumstances, however, it is also possible to start operation in a state in which the data is recorded previously. In addition to the number of past manufactured articles, a scheduled value of the number of articles to be manufactured thereafter may be included. To be concrete, for example, data as shown in FIG. 8 is recorded. In FIG. 8, each row represents the number of manufactured articles for every product and every manufacture year.

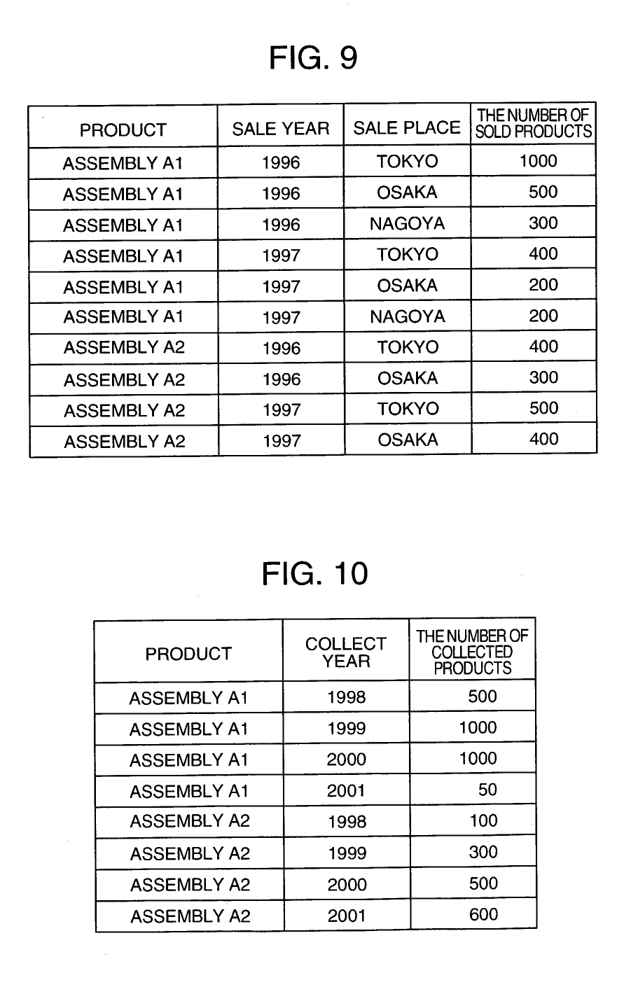

As the product attribute data, the number of sold articles, the number of times of repair, and the number of recovered articles can also be handled besides the number of manufactured articles for every manufacture year. Data divided into units, such as terms of different units like months or areas, can also be handled. In other words, attribute data with a product taken as the unit can be universally handled. For example, FIG. 9 shows an example of data that represent the number of sold articles by combining terms and areas. FIG. 10 shows an example of data that represent the number of products used and recovered after being sold. Although how to use then will be described later, the product attribute data can be processed in the same way as manufacture data.

A part attribute development processing unit 105 creates attribute data with a part taken as the unit, on the basis of product data recorded in the product data storage region (1) 108 and attribute data with a product and a term each taken as the unit recorded in the product attribute data storage region 109. The attribute data with a part taken as the unit thus created is recorded in a part attribute data storage region 111.

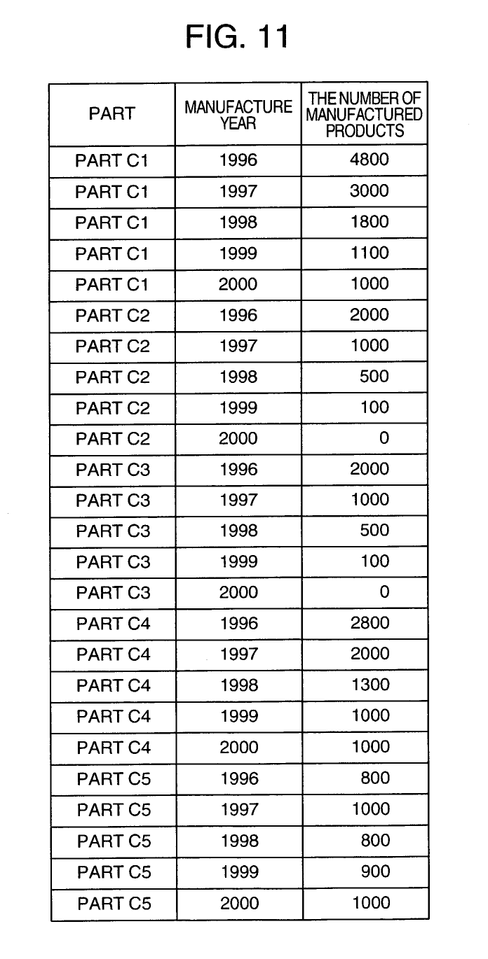

FIG. 11 shows an example of the attribute data with a part taken as the unit recorded in the part attribute data storage region 111. The data represents the number of manufactured articles for every part at the time when the number of articles shown in FIG. 8 were manufactured with respect to the assemblies A1 and A2 shown in FIG. 6. Each row represents the number of articles for a part and a manufacture year. For example, 4,800 articles were manufactured in the year of 1996 for the part C1, and 1,000 articles were manufactured in the year of 1997 for the part C2.

Calculation for obtaining this will now be described. Taking the number of manufactured articles for the part C1 in 1996 as an example, it is obtained by following a line leftward from the part C1 in FIG. 6. It will be appreciated that the number of manufactured articles for the part C1 in 1996 is obtained first as the sum of the number of manufactured articles for the subassembly B1 and the number of manufactured articles for the subassembly B2, and in addition as the sum of the number of manufactured articles for the assembly A1 and the number of manufactured articles for the assembly A2. Numerically, the number of manufactured articles for the part C1 in 1996 becomes 2,000+2,000+800=4,800.

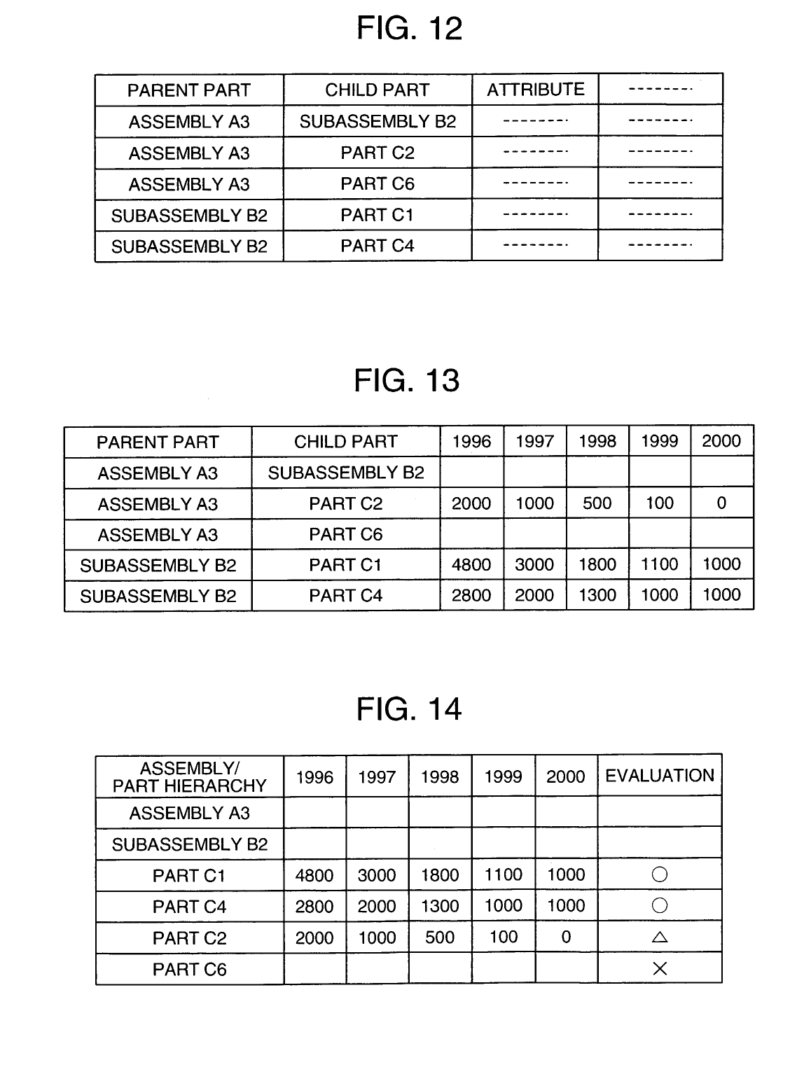

In a product data storage region (2) 110, data concerning a product now under the design is recorded. Typically, this data is input typically from the input device 101. Depending on circumstances, however, it is also possible to start operation in a state in which the data is recorded previously. The recorded product data is, for example, data as shown in FIG. 5. It is proper to store such data in a form that can be easily handled by a computer. In the case where the data is recorded in the storage region, the data is recorded in, for example, a form shown in FIG. 12 in the same way as the case of FIG. 7 in order to make the data easy to handle in the computer.

For example, when studying a plurality of plans, it is also possible to accept data for specifying a plan or a product from the input device 101, and conduct processing described below on only pertinent data on the basis of the accepted data. Furthermore, it is also possible to put together the product data storage region (1) 108 and the product data storage region (2) 110 to form one storage device. In this case as well, it is also possible to accept data for specifying a plan or a product from the input device 101, and conduct processing described below on only pertinent data on the basis of the accepted data.

An attribute association processing unit 106 reads attribute data with a part taken as the unit recorded in the part attribute data storage region 111, and data of a product now under design recorded in the product data storage region (2) 110. The attribute association processing unit 106 associates parts on the basis of the data thus read, creates data obtained by combining product data and attribute data with a part taken as the unit, and records the created data in a product data with attribute storage region 112.

FIG. 13 shows an example of data recorded in the product data with attribute storage region 112. The data is data obtained by associating the data concerning the number of manufactured articles for every part included in the past products A1 and A2 shown in FIG. 11 with data concerning products under the design shown in FIG. 12. In FIG. 13, data in the fields of the parent part and the child part shown in two left columns remain the same as the data shown in FIG. 12. In the third column and subsequent columns, the numbers of manufactured articles in respective years are associated as attributes of child parts shown in respective rows.

An evaluation and output processing unit 107 evaluates product data having attributes recorded in the product data with attribute storage region 112, and outputs the product data with the evaluation to the display device 104. A typical output method is a screen display. However, the evaluation and output processing unit 107 may be connected to another computer system, and may output the data. At this time, the evaluation and output processing unit 107 makes a decision on attribute contents on the basis of predetermined conditions, adds a field of evaluation according to the result, and outputs resultant data. The colors and shapes may be altered according to the result of the decision.

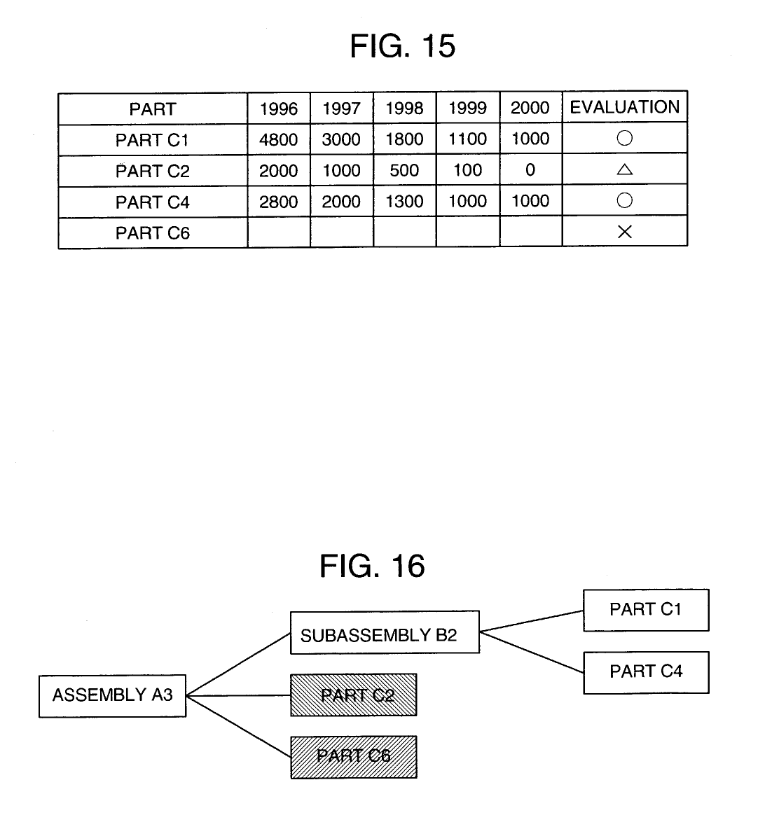

Typical output forms are shown in FIGS. 14, 15 and 16. In FIG. 14, a part configuration of a hierarchical structure of a product is output to a field of assembly/part hierarchy, and the number of articles and an evaluation result of the pertinent part in every year are output to the right side of each part. In FIG. 15, a list of only parts included in a subject product, and the number of manufactured articles and an evaluation result of every part in every year are output. Except for the evaluation field, the display form is the same as data concerning the number of manufactured articles for the parts included in the past products A1 and A2 and shown in FIG. 11. FIG. 11 shows a list of all past enormous parts included in a large number of past products recorded in the product data storage region (1) 108. FIG. 15 shows a list of only parts included in a currently noticed product.

FIG. 16 is a hierarchical structure diagram of the assembly A3. The hierarchical structure diagram is output with parts hatched according to the evaluation result. The part C6 having no past data and the part C2 reduced in recent number of articles are hatched. Furthermore, the hatching form is changed according to the evaluation result. Besides, there are discrimination forms using a coloring output or a bold type output.

Evaluation in FIGS. 14 and 15 is conducted by using a method described below. First, a part that has not been manufactured until now is marked with “x”. To be concrete, a decision is made on the basis of the fact that data of the part does not exist in attribute data with a part taken as the unit recorded in the part attribute data storage region 111. A part that was manufactured before and that is not manufactured recently is marked with “Δ”. To be concrete, a decision is made on the basis of the fact that the number of recently manufactured articles in the attribute data is 0. A part that has been manufactured until recently is marked with “o”. This decision corresponds to a part that is neither “x” nor “Δ”.

The designer refers to the output result sometimes in the middle of the design, and determines whether a part marked with x or Δ can be replaced by a part marked with o. In the product design, it is recommended to use a part used in the past and reduce the kinds of manufactured parts. By using the result of the present system, a decision on parts to be studied on improvement is facilitated. Even if a part has been fabricated before, it is necessary to add it to the stock, provided that it has not been manufactured recently, resulting in a high possibility of an increased cost. By making a decision on a recent manufacture situation and outputting a result of the decision, therefore, a decision on parts that need the study of improvement is facilitated.

In the foregoing description, it has been assumed that the attribute data is the number of manufactured articles. Besides it, data, such as the number of sold articles, the number of repaired articles, the number of recovered articles, and the number of recycled articles, can also be handled in the product data processing device according to the present invention. In the conventional design, whether there is an actual result of past manufacture is used as a part selection criterion. In some cases, however, it is proper to use the number of sold, repaired, recovered or recycled articles.

As for manufactured and sold products, parts replaced at the time of maintenance are needed in some cases. Therefore, it is usual that service centers are disposed in the areas where the products were sold and the service centers have stock of parts for replacement. If a new product is sold, then it is necessary to add stock of parts newly used for the product. If parts used before, especially parts used in products recently manufactured in large numbers are used, then it is not necessary to add a new stock. Furthermore, as for a product, all models are not necessarily sold all over the country. In the case where a product is sold in restricted areas, it is sufficient that there is a stock of replacement parts for repair in each of the restricted areas, and consequently it is effective to grasp the regional distribution amounts. In the same way, since there is a possibility that the number of times of repair differs according to the failure probability, data concerning the number of times of repair also furnishes with useful information.

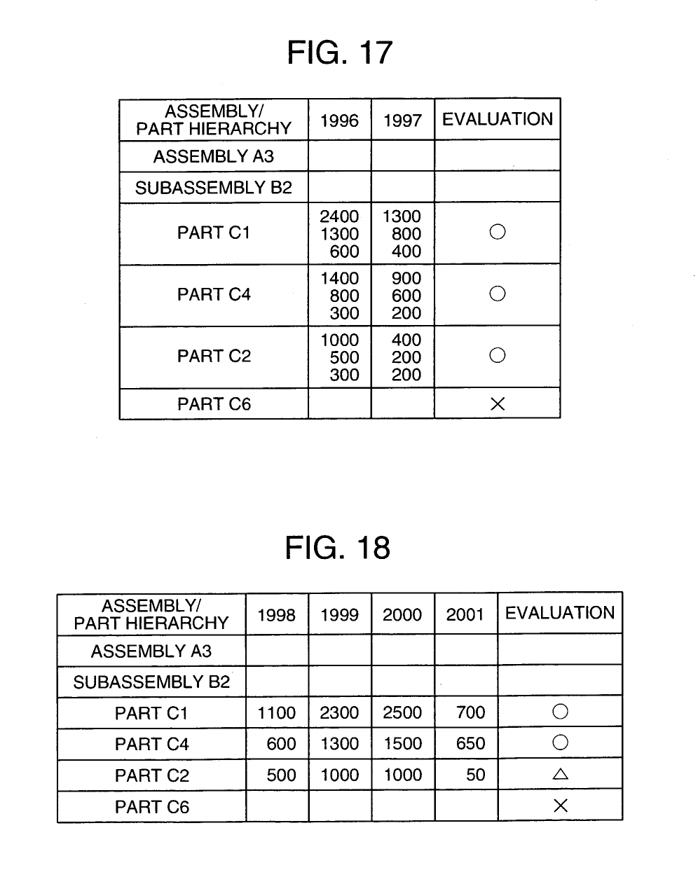

FIG. 17 is an output diagram showing the numbers of sold articles for parts included in a product now under the design, which are obtained from the data concerning the numbers of sold articles for products. In FIG. 17, three numerical values shown in each frame represent values in three areas, such as Tokyo, Osaka and Nagoya. In this example, there are no parts for which the number of sold articles decreases extremely. If there is an area where the number of articles for some part has decreased, however, the stock for repair of the part gradually becomes unnecessary in the area. If the part is reused in design of a new product, it is necessary to increase the stock for repair.

After a manufactured product has been used, it is recovered and recycled in some cases. In the recycle, a detached part is used in a new product again sometimes. From data concerning the number of articles for a product recently recovered and recycled, data concerning the quantities of parts included in the product is calculated and exhibited. By using parts recently recovered in large numbers for a new product, the reuse factor can be increased. Especially in recovery and recycle, the term of the recovery and recycle is different from the manufacture term of the original product. Therefore, it is effective that this data can be referred to in the design stage. In the ensuing description, it is assumed that the number of recovered articles is equal to the number of recycled articles.

FIG. 18 is an output diagram showing the numbers of actually recovered articles for parts included in a product now under the design, which are obtained from the data concerning the numbers of recovered articles for products. In the case where recycled parts are reused for the product, the parts C1 and C4 are recovered with comparative stability, and consequently a possibility that the parts C1 and C4 can be reused is high. Since the number of recovered articles for the part C2 is decreased remarkably, however, its reuse becomes difficult. Therefore, it becomes necessary to determine whether the part can be replaced by another part that is larger in recovered quantity.

Operation of the product data processing device will now be described. It is assumed as the occasion demands that the product attribute data includes the number of sold articles or the number of recovered (recycled) articles besides the number of manufactured articles.

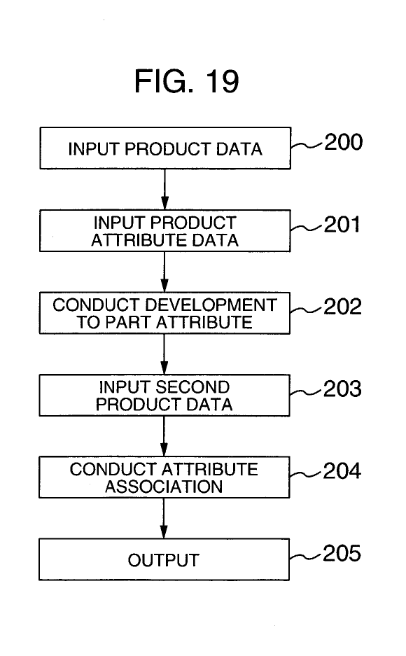

FIG. 19 shows a processing procedure of the product data processing device. This procedure is stored in the program storage unit 102 as a program. First, product data is input (200). To be concrete, data of past products is input from the input device 101, and the data is recorded in the product data storage region (1) 108. The data is, for example, the data as shown in FIG. 6 or FIG. 7.

Subsequently, the product attribute data is input (201). To be concrete, data concerning the numbers of manufactured articles for past products in every term is input from the input device 101, and the data is recorded in the product attribute data storage region 109. The data is, for example, the data as shown in FIG. 8, FIG. 9, or FIG. 10.

Subsequently, development to part attributes is conducted (202). To be concrete, the part attribute development processing unit 105 reads product data recorded in the product data storage region (1) 108 and attribute data with a product and a term taken as the unit recorded in the product attribute data storage region 109, and creates attribute data with a part taken as the unit. The part attribute development processing unit 105 records the created attribute data in the part attribute data storage region 111. In the case of the number of manufactured articles, the data is the data as shown in FIG. 11. Details of the processing will be described later.

Subsequently, second product data is input (203). To be concrete, the second product data is read from the input device 101, and the second product data is recorded in the product data storage region (2) 110. The data is, for example, the data as shown in FIG. 5 or FIG. 12.

Subsequently, attribute association is conducted (204). The attribute association processing unit 106 reads attribute data with a part taken as the unit recorded in the part attribute data storage region 111, and data of a product now under design recorded in the product data storage region (2) 110, and associates parts. And the attribute association processing unit 106 creates data obtained by combining product data and attribute data with a part taken as the unit, and records the created data in the product data with attribute storage region 112. In the case of the number of manufactured articles, the data is the data shown in FIG. 13. Details of this processing will be described later.

Finally, outputting is conducted (205). To be concrete, the evaluation and output processing unit 107 evaluates product data having attributes recorded in the product data with attribute storage region 112, and displays the product data together with the evaluation on the display device 104 as shown in, for example, FIG. 14.

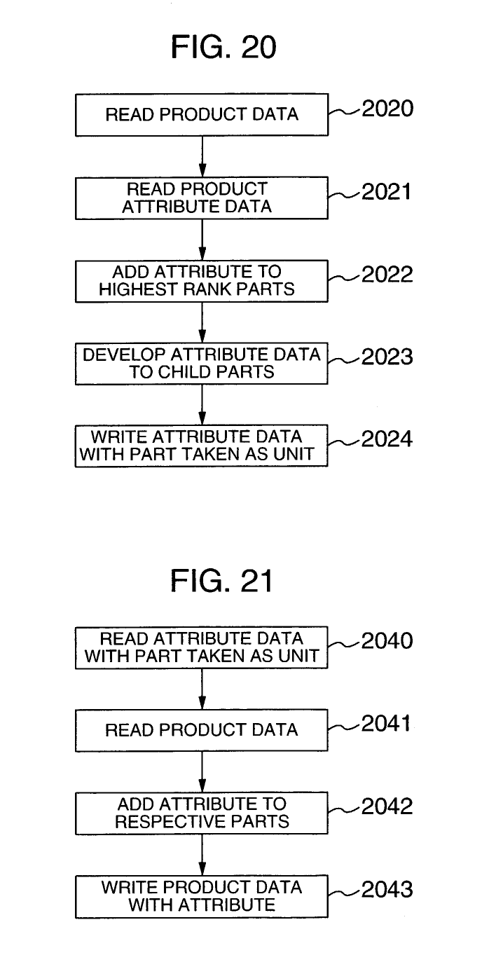

FIG. 20 shows a procedure for processing of development to part attributes. The development to the part attributes (202) described earlier is conducted by the part attribute development processing unit 105. First, product data is read (2020). To be concrete, the part attribute development processing unit 105 reads product data recorded in the product data storage region (1) 108. This data is, for example, the data shown in FIG. 6. In the case where the data is handled by a computer, the table form shown in FIG. 7 is desirable.

Subsequently, product attribute data is read (2021). To be concrete, the product attribute data recorded in the product attribute data storage region 109 as shown in FIG. 8 is read.

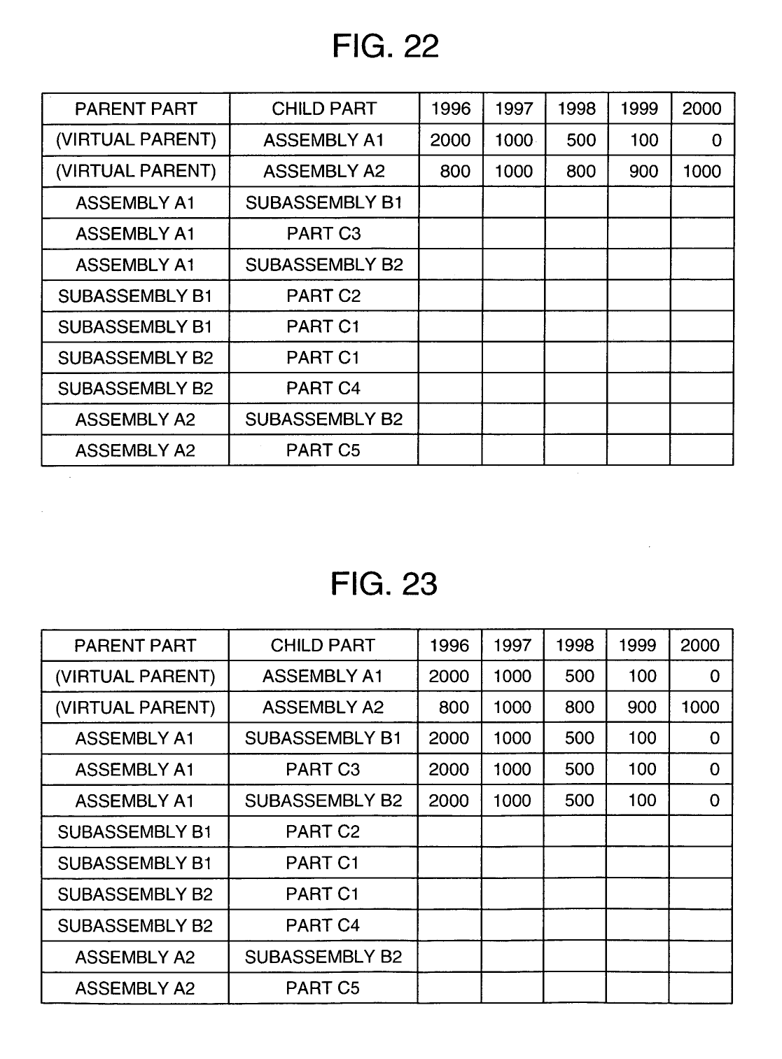

Subsequently, addition of the attribute to the highest rank parts is conducted (2022). To be concrete, in each row of the product attribute data, corresponding attribute data are added to the highest rank parts of the pertinent product. If, for example, the product data is shown in FIG. 7 and the product attribute data is shown in FIG. 8, then data in each row shown in FIG. 8 is associated with the corresponding parent part shown in FIG. 7. For providing a parent part with an attribute, various schemes are conceivable. For example, if virtual parent parts are introduced as shown in FIG. 22, then they can be advantageously processed in the same way as other parts.

Subsequently, development of the attribute data to child parts is conducted (2023). To be concrete, while tracing a branch from the highest rank part of each product data subsequently to lower rank parts, a numerical value of attribute data added to a parent part is added to attribute data of a child part. This can be conducted by using the following method.

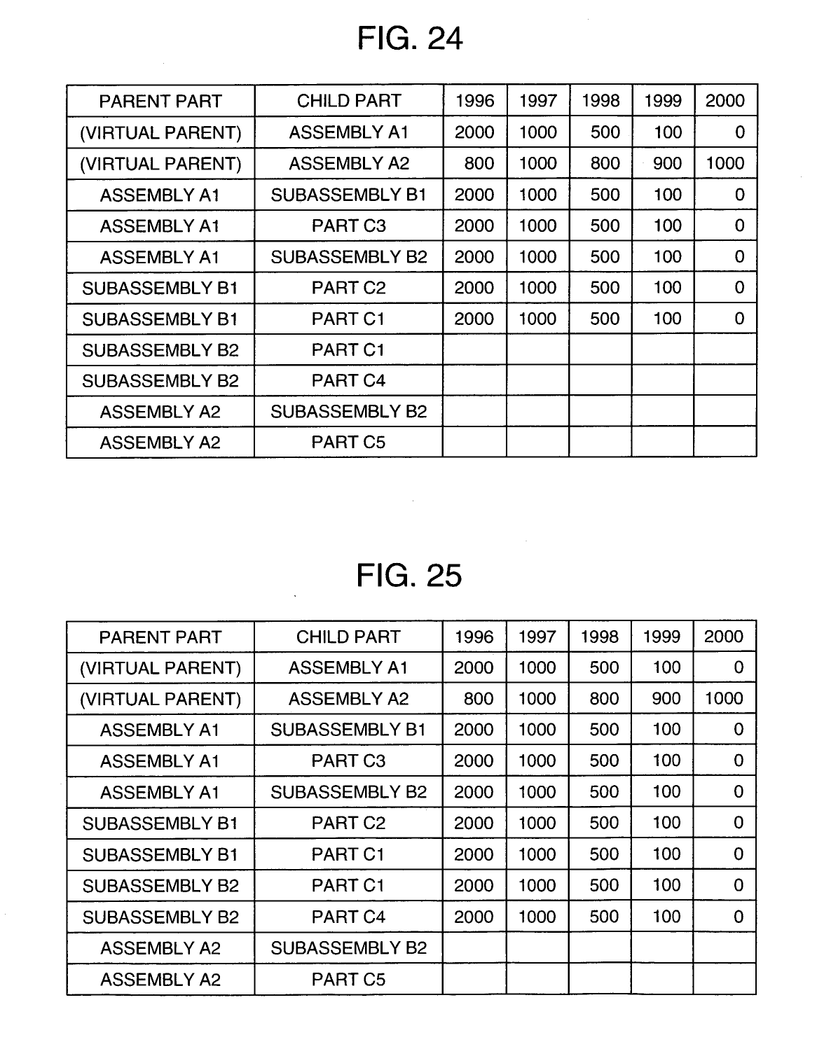

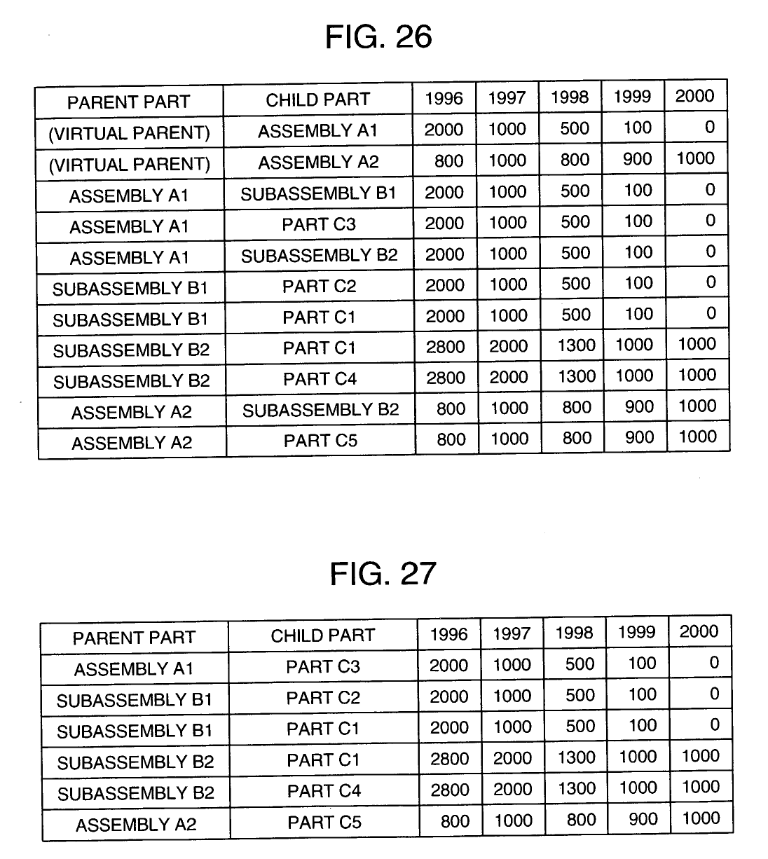

With respect to the data shown in FIG. 22, the attribute values of the parent part are added to child parts for the highest rank assembly A1. FIG. 23 shows a result of this. In addition, with respect to the subassembly B1, which is a child part, child parts thereof are developed as shown in FIG. 24. With respect to the subassembly B2, child parts thereof are developed as shown in FIG. 25. Thereby, development processing for the assembly A1 is finished. If development processing is conducted for the assembly A2 as well in the same way, then a result shown in FIG. 26 is obtained.

Finally, the attribute data with a part taken as the unit is written (2024). To be concrete, with respect to all parts having no child, accompanying attribute data are recorded in the part attribute data storage region 111. To be concrete, by leaving parts having no child from FIG. 26, FIG. 27 is obtained. By conducting addition for the same parts, FIG. 11 is obtained.

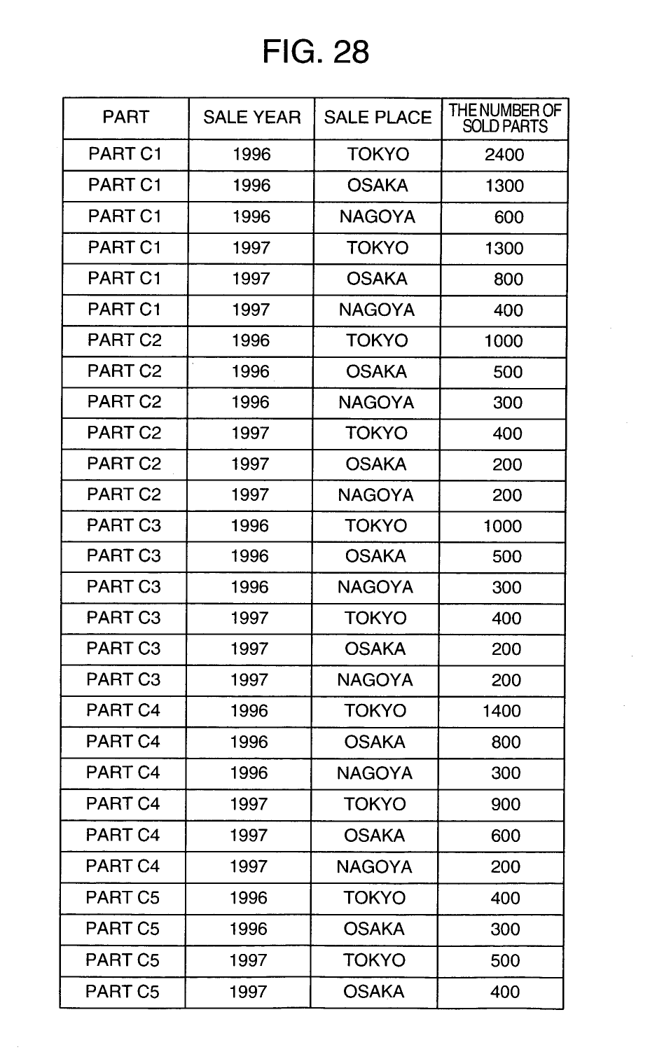

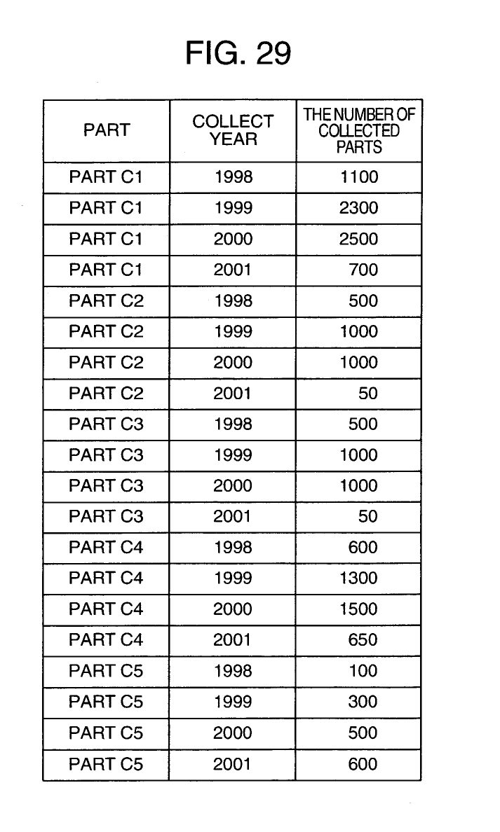

If similar processing is applied to the number of sold articles shown in FIG. 9, then FIG. 28 is obtained. FIG. 28 shows an example of part attribute data having the number of sold articles as an attribute. By associating the second product data shown in FIG. 12 therewith, product data including the number of sold articles and evaluation as shown in FIG. 17 is obtained. If similar processing is applied to the number of recovered articles shown in FIG. 10, then FIG. 29 is obtained. FIG. 29 shows an example of part attribute data having the number of recovered articles as an attribute. By associating the second product data shown in FIG. 12 therewith, product data including the number of recovered articles and evaluation as shown in FIG. 18 is obtained.

FIG. 21 shows a procedure for attribute association processing. The attribute association (204) is conducted by the attribute association processing unit 106. First, attribute data with a part taken as the unit is read (2040). This data is, for example, the data shown in FIG. 11, FIG. 28 or FIG. 29. To be concrete, the attribute data with a part taken as the unit recorded in the part attribute data storage region 111 is read.

Subsequently, product data is read (2041). To be concrete, data of the product now under design recorded in the product data storage region (2) 110 is read. This data is, for example, the data shown in FIG. 12.

Subsequently, addition of the attribute to respective parts is conducted (2042). To be concrete, with respect to each of parts included in the product, attribute data corresponding thereto is searched for. If the data exists, then the data is recorded as the attribute of the part. To be concrete, data in FIG. 11 that coincides with the field of child part in FIG. 12 is recorded as the attribute. As a result, FIG. 13 is obtained.

Finally, the product data with attribute is written (2043). To be concrete, the product having the attribute added thereto is recorded in the product data with attribute storage region 112 together with the added attribute data.

As heretofore described, product data classified by part and provided with the actual result number of articles for each year and each area can be obtained according to the present embodiment. By adopting parts having actual results, therefore, reliability of the product can be improved. Furthermore, in the product design, a decision on parts to be studied as to improvement is facilitated. Especially, since evaluation is given in the output, study problems, such as whether parts marked with x or Δ can be replaced by o, are also clarified.

Furthermore, in the present product processing device, not only actual results of past manufacture, but also data, such as the number of sold articles, the number of repaired articles, and the number of recovered (recycled) articles, can be handled. Furthermore, with respect to each of them, not only the temporal unit, but also the regional unit can be handled. As a result, in the product design, it becomes possible to study the number of spare articles according to the number of sold articles, and study as to whether supply of parts is difficult according to the number of recovered articles and as to part alteration.

According to the present invention, it is possible to output product attributes for a specified product and attribute kind, while taking a part as the unit, so as to correspond to the product configuration, by using the product configuration data and attribute data with a product as the unit prepared beforehand. If this information is used in the design and development stage, then it is possible to judge the situation of manufactured, sold, and recovered (recycled) parts for each term and each place with respect to a new product, and it is possible to improve the reliability and productivity and cost reduction in designed products by using parts having actual results.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A product data processing method for creating data for selecting parts in product design from past product data, comprising the steps of:
creating and storing part attribute data corresponding to parts from a hierarchical parts structure of a product and attribute data of the product; and
searching for said stored attribute data with a part taken as the unit on the basis of input new product data, adding to each of pertinent parts its attribute data to thereby create product data with attribute corresponding to the new product data.

2. The product data processing method according to claim 1, wherein
the hierarchical structure of the product data comprises hierarchical structure data including at least one assembly and subassembly and a plurality of parts, and
said product attribute data is the number of manufactured articles, the number of sold articles, or the number of recovered articles with an assembly taken as the unit.

3. The product data processing method according to claim 1, wherein attribute data in the product data with attribute is evaluated from part to part, and the attribute data is displayed together with a result of the evaluation.

4. A product data processing device comprising a computer and for creating data for selecting parts in product design from past product data, said product data processing device, comprising:
a storage storing product configuration data that represents a part configuration for each of a plurality of products, and product attribute data that represents attribute information concerning each of the products;
a part attribute development unit which develops the product configuration data and the product attribute data read from said storage into those in part units to create part data with attribute;
a storage storing product configuration data that represents a part configuration of a second product;
an attribute corresponding unit which corresponds to parts included in the product configuration data of the second product with product attribute data in said part data with attribute supplied from said part attribute development unit for each of the parts; and
an output unit for evaluating an attribute value of the product attribute data corresponding to each of parts included in the second product on the basis of an output of said attribute corresponding unit.

5. The product data processing device according to claim 4, wherein the product attribute data is a number of manufactured articles, a number of sold articles, or a number of recovered articles in each term and/or area.

6. A product data processing device comprising a computer and creating data useful for adopting parts in product development on the basis of past product data, the product data processing device, comprising:
a storage unit for storing product manufacture number data that represents a number of manufactured articles for each of a plurality of products and each term, and product configuration data that represents a part configuration for each product;
a part attribute development unit for developing the data that represents the number of manufactured articles for each product and parts included in the product configuration data by taking a part as unit to create part data with attribute;
a storage unit for storing product configuration data that represents a part configuration of a second product;
an attribute association unit for associating parts included in the product configuration data of the second product with the number of manufactured articles in the part data with attribute supplied from said part attribute development unit for each of the parts, and creating product data with attribute for each part; and
an output unit for evaluating the number of manufactured articles for each of parts included in the product data with attribute on the basis of an output of said attribute association unit.

7. A program of a computer device for executing a product data processing method in order to create data useful for product development on the basis of past product data,
wherein the program of the computer device executes the product data processing method according to claim 1.

8. A storage medium for storing a program, the program being used to execute a product data processing method in a computer device in order to create data useful for product development on the basis of past product data,
wherein the program of the computer device executes the product data processing method according to claim 1.

9. A program of a computer device for executing a product data processing method in order to create data useful for product development on the basis of past product data,
wherein the program of the computer device executes the product data processing method according to claim 2.

10. A program of a computer device for executing a product data processing method in order to create data useful for product development on the basis of past product data,
wherein the program of the computer device executes the product data processing method according to claim 3.

11. A storage medium for storing a program, the program being used to execute a product data processing method in a computer device in order to create data useful for product development on the basis of past product data,
wherein the program of the computer device executes the product data processing method according to claim 2.

12. A storage medium for storing a program, the program being used to execute a product data processing method in a computer device in order to create data useful for product development on the basis of past product data,
wherein the program of the computer device executes the product data processing method according to claim 3.

13. A product data processing method for generating data useful for adopting parts in a planned product on the basis of past product data, comprising the steps of:
developing input product data indicating a hierarchical structure of a product and attribute data of the product into those data in part units, and generating and holding part data with attribute, on the basis of the product data and the attribute data; and
searching for the held attribute data with in part units with respect to input new product data, adding to each of pertinent parts its attribute data to create product data with attribute corresponding to the new product data.
